(19) United States
(12) Patent Application Publication
(10) Pub. No.: US 2003/0089836 A1
(43) Pub. Date: May 15, 2003

(54) Device for handling and shaping bread dough

(76) Inventor: Manuel Sousa, Newport, RI (US)

Correspondence Address: BARLOW, JOSEPHS & HOLMES, LTD., 101 DYER STREET, 5TH FLOOR, PROVIDENCE, RI, 02903, US

(21) Appl. No.: 10/292,357

(22) Filed: Nov. 12, 2002

Related U.S. Application Data
(60) Provisional application No. 60/337,835, filed on Nov. 13, 2001.

(51) Int. Cl. A21C 13/00

(52) U.S. Cl. 249/119; 249/163

(57) ABSTRACT

The present invention provides a device for suspending a loaf of bread dough throughout the final rise step and for subsequent transfer to the baking location by gently rolling the loaf from the device without having to manually handle the dough, thus preserving the rise and the shape of the loaf. The present invention has two end support structures that are attached by removable lateral supports. The loaf support components include a fabric web and two rigid longitudinal members. The ends of the longitudinal members are then placed between the end supports in contact with top edge of the end supports. As a result, the fabric web is therefore supported along two edges between the end supports and is suspended over the work surface forming a downwardly depending u-shaped pocket. The loaves of bread dough are placed individually into the fabric pockets and are supported in a uniform manner transferring pressure along the entire bottom and critical side surfaces of the rising bread loaf.

### CROSS-REFERENCE TO RELATED APPLICATIONS

This application is related to and claims priority from earlier filed provisional patent application No. 60/337,835, filed Nov. 13, 2001.

### BACKGROUND OF THE INVENTION

The present invention relates to a new device for supporting and handling bread dough during its final rise and transfer into the oven for baking. More specifically, the present invention relates to a support device for use in cradling loaves of bread dough to allow the dough to rise having uniform support while remaining substantially undisturbed during the final rise and transfer into the oven.

Currently, there are several devices available that are configured for use by bakers to assist is protecting and shaping loaves of bread dough during the final rise and transfer to the baking surface. One general category of these devices includes pans. Generally, pans are provided into which a loaf of dough is placed where it remains through the final rise and entire baking process. In some instances, they are designed to handle a single loaf of dough, while others have an array of openings to handle multiple loaves. The drawback however is that as the dough rises, its is only supported along the first half of the loaf height, allowing the top half to expand beyond the sides of the pan giving the finished loaf a pinched appearance.

Another general category uses pockets formed from a stiff material. This method involves a sheet of stiff canvas or baking paper that is placed in an undulating fashion on the counter forming pockets into which the dough is placed for rising. After the rise is complete, in order to transfer the dough for baking, the dough must be lifted by hand from the pockets. This handling often collapses the final rise causing a deformation in the shape of the finished loaf. In addition, because the support for this type of system is the counter, often the bottom of the loaf has a very flat and spread out appearance thus not providing a desirable round shape.

Finally, there is a device in the prior art that provides for holding the dough in a fixed, suspended pocket. However, as described above, in order to transfer the dough to the baking surface, it must be removed from the pocket by hand. Again, this introduces the possibility of deflating the loaf or causing deformation.

Another drawback to the present state of the art is the fact that the existing systems all support the loaves from the bottom, since the desired dough texture for many types of bread is typically on the wet side, it tends to be looser in texture and therefore more susceptible to spreading. Intrinsically, the bottom support methods therefore result in a flat-bottomed loaf. In addition, there is no space provided beneath the rising loaf in the event a pan of hot water is necessary to assist in controlling the environment in which the dough rises.

There is therefore a need for a unique device for supporting bread dough that provides the ability to maintain the shape of the loaf during the final rise and transfer to the baking surface that eliminated the need for touching the risen loaf with the user's hands.

### BRIEF SUMMARY OF THE INVENTION

In this regard, the present invention provides for a novel device that supports loaves of bread dough in a suspended manner to maintain a uniform round loaf shape during the final rise of the bread dough while also facilitating the transfer of the dough to the baking surface without the user contacting the dough with his/her hands.

In accordance with the present invention a device is provided whereby the loaf of bread dough is suspended throughout the final rise and is subsequently transferred to the baking location by gently rolling the loaf from the device without having to manually handle the dough, thus preserving the rise and the shape of the loaf. The present invention has two end support structures that are attached by removable lateral supports. The two lateral supports extend along the bottom of the end supports adjacent to the work surface and are removable to allow the device to be collapsed and stored. When in use the lateral supports hold the end supports in fixed spaced relation relative to one another and allow the user to adjust the spacing as desired. The end supports are held in an upright position capable of receiving and supporting the bread loaf support components.

The bread support components include a fabric web and two rigid longitudinal members. The fabric web has support ribs that are formed along two of its edges to receive the longitudinal members. The longitudinal members are two rods that are inserted into the support ribs of the fabric web having each of their respective ends protruding from the support ribs. The ends of the longitudinal members are then placed between the end supports in contact with top edge of the end supports. As a result, the fabric web is therefore supported along two edges between the end supports and is suspended over the work surface forming a downwardly depending u-shaped pocket. The loaves of bread dough are placed individually into the fabric pockets and are supported in a uniform manner transferring pressure along the entire bottom and critical side surfaces of the rising bread loaf without resting on a hard flat-bottomed surface.

After the dough has completed its final rising process, the bread support device is removed from the end supports. This is done simply by lifting on the ends of the longitudinal supports that are resting on the top edge of the end supports. The loaf is simply rolled onto the baking surface by releasing one side of the longitudinal supports. As can be seen this eliminates the requirement of handling the loaf and allows the loaf to be completely supported during the entire transfer process.

Accordingly, one of the objects of the present invention is the provision of device for supporting at least one loaf of bread dough during its final rise step. Another object of the present invention is the provision of a device for supporting a loaf of bread dough during its final rise step and facilitating its transfer to a baking surface without the requirement of touching the dough with the user's hands. A further object of the present invention is the provision of a device that suspends a loaf of bread dough over the work surface in a removable pocket that provides a uniform round shape to the bottom of the loaf. Yet another object of the present invention is the provision of a collapsible device that suspends a loaf of bread dough in a removable pocket that allows the dough to be transferred to a baking surface without requiring the user to touch the dough with their hands.

Other objects, features and advantages of the invention shall become apparent as the description thereof proceeds when considered in connection with the accompanying illustrative drawings.

### BRIEF DESCRIPTION OF THE DRAWINGS

In the drawings which illustrate the;best mode presently contemplated for carrying out the present invention:

FIG. 1 is a perspective view of the bread loaf support device of the present invention;

FIG. 2 is a top view thereof with a loaf of bread dough therein; and

FIG. 3 is a top view thereof in a disassembled state showing the removable bread supports.

### DETAILED DESCRIPTION OF THE INVENTION

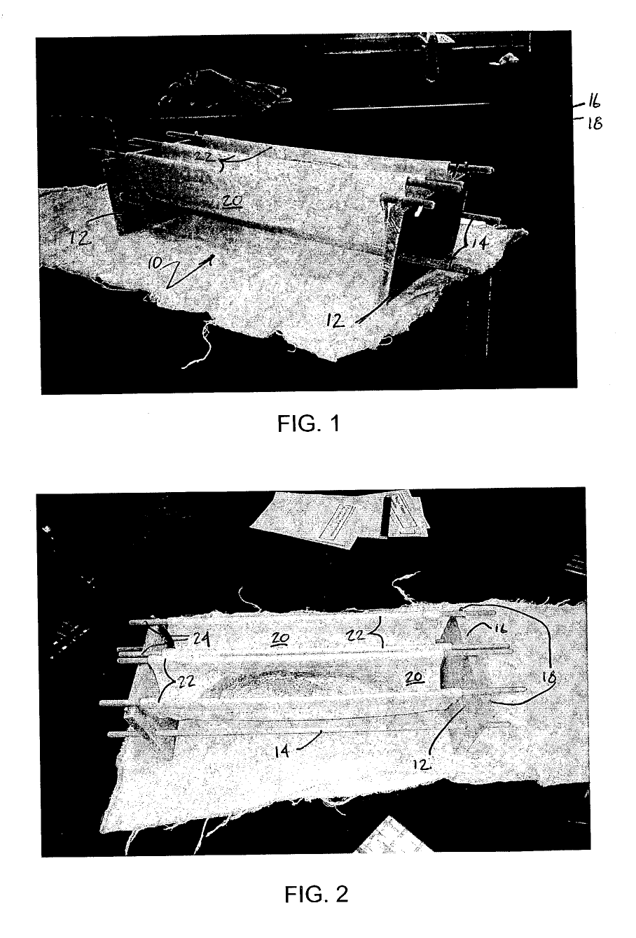

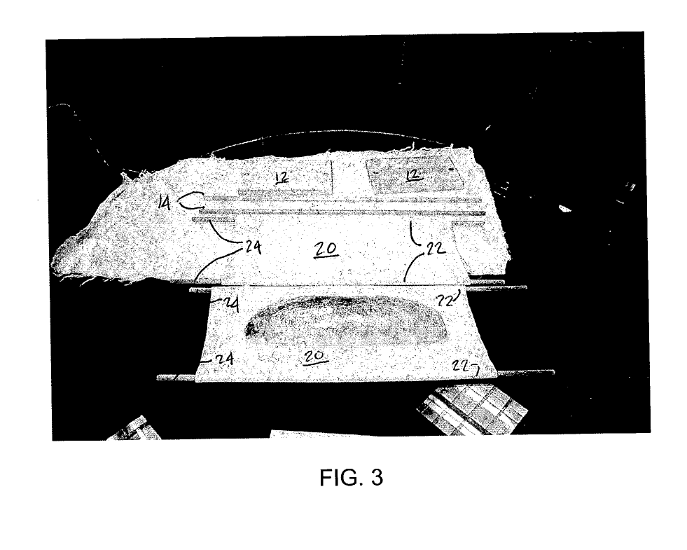

Referring now to the drawings, the combination bread dough support device of the present invention is illustrated and generally indicated at 10 in FIGS. 1-3. As will hereinafter be more fully described, the device has two general elements, a base support section and a dough support section. The base support includes two end support members 12 held in spaced relation by a removable longitudinal member 14. The end support members 12 are slideably connected to the removable longitudinal member 14 to allow adjustments in the length of the device 10. The end supports 12 have top edges 16 that are adapted to receive at least one dough support sections. At the respective ends of the top edges 16 of the end supports 12 are retention members 18 that prevent the dough support sections from unintentionally sliding off the top edges 16 and subsequently out of the base section.

The dough support section includes a flexible fabric carrier 20 having pockets 22 fashioned into two opposing edges thereof. The fabric is preferably canvas but may be any other fabric suitable in this application. Longitudinal support rods 24 are placed into the pockets 22 along the edges of the fabric carrier 20. The support rods 24 extend slightly beyond the ends of the pockets 22. In this fashion the dough support section is placed into the base section with the exposed ends of the support rods 24 resting on the top edges 16 of the end supports 12 between the retention members 18. In this position, the fabric carrier 20 forms a downwardly depending U-shaped pocket that drapes from and is supported by the support rods 24. Once assembled in this fashion a loaf of bread dough can be placed into the pocket 20 for the final rising step.

After the dough has completed its final rising process, the bread support device 10 is removed from the end supports 12. This is done simply by lifting on the ends of the longitudinal support rods 24 that are resting on the top edge 16 of the end supports 12. The loaf is simply rolled onto the baking surface by releasing one side of the longitudinal supports 24. As can be seen this eliminates the requirement of handling the loaf and allows the loaf to be completely supported during the entire transfer process.

Finally, the present invention is capable of easy disassembly. This allows the device to be compactly stored when not in use.

It can therefore be seen that the present invention provides a unique and novel bread loaf support device 10 that allows bread dough to be fully supported in pocket 20 having a desirable shape. Further, the present invention provides a device that eliminates the need for physically handing the bread dough after its final rise for transfer to the baking surface. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. An assembly for supporting rising bread dough comprising:
a pair of end supports, said end supports each having a top edge and a bottom edge;
at least one longitudinal support member removably connected to said end supports for maintaining said end supports in a spaced apart position;
at least one flexible fabric support means having a rod channel disposed along each of two opposed parallel edges thereof;
at least two intermediate support rods selectively arranged to support said at least one flexible fabric support by passing said intermediate support rods through said rod channels wherein a portion of each end of said support rods extends beyond the limits of said rod channels; and
retention means at each respective end of said top edges of said end supports, wherein said exposed portion of said ends of said support rods rests on said top edge of said end supports between said retention means causing said flexible fabric support to form a downwardly depending pocket into which a loaf of bread can be placed.
